(19) United States
(12) Patent Application Publication
(10) Pub. No.: US 2026/0163626 A1
(43) Pub. Date: Jun. 11, 2026

(54) EARLY CHANNEL QUALITY INDICATOR REPORTING FOR MOBILE TERMINATED-SMALL DATA TRANSMISSIONS

(71) Applicant: Telefonaktiebolaget LM Ericsson (PUBL), Stockholm (SE)

(72) Inventors: Revathy NARAYANAN, SOLLENTUNA (SE); Sandeep Narayanan KADAN VEEDU, Järfälla (SE); Andreas HÖGLUND, SOLNA (SE); Jan CHRISTOFFERSSON, LULEÅ (SE)

(21) Appl. No.: 19/150,131

(22) PCT Filed: Feb. 15, 2024
(86) PCT No.: PCT/SE2024/050143

§ 371 Date: Jul. 22, 2025

Related U.S. Application Data
(60) Provisional application No. 63/485,103, filed on Feb. 15, 2023.

(51) Int. Cl. H04B 7/06; H04W 72/23; H04W 74/0833

(52) U.S. Cl. CPC H04B 7/0626; H04W 72/23; H04W 74/0833

(57) ABSTRACT

A method (1000) is provided by a user equipment, UE (112), configured for Mobile Terminated-Small Data Transmission, MT-SDT for early Channel Quality Indicator, CQI, reporting. The method includes receiving (1002), before a Radio Resource Control, RRC, connection is established with a network node (110), information indicating at least one Reference Signal, RS. The UE receives (1004), from the network node, the at least one RS. Based on the at least one RS, the UE performs (1006) at least one CSI measurement. Before the RRC connection is established with the network node, the UE transmits (1008), to the network node, CSI associated with the at least one CSI measurement.

### TECHNICAL FIELD

The present disclosure relates, in general, to wireless communications and, more particularly, systems and methods for early Channel Quality Indicator (CQI) reporting for Mobile Terminated-Small Data Transmission (MT-SDT).

### BACKGROUND

In Release 17, Mobile Originated Small Data Transmission (MO-SDT) was introduced for NR to reduce the signaling overhead for small uplink data payloads. See, RP-200954, New Work Item on NR small data transmissions in INACTIVE state. Two solutions were introduced, Random Access-based-Small Data Transmission (RA-SDT) and Configured Grant-Small Data transmission (CG-SDT). According to RA-SDT, the legacy 4-step Random Access Channel (RACH) procedure (or 2-step RACH procedure) is used as a baseline with the exception that a user-plane data payload can be appended (multiplexed with the RRCResumeRequest message) in a Msg3 in the 4-step RA access procedure (or a MsgA in a 2-step RA access procedure). According to CG-SDT, the UEs are configured via Radio Resource Control (RRC) to have periodic CG-SDT occasions, which are contention-free and can be used for uplink (UL) transmission. In this way, Msg1 and Msg2 can be omitted, but it is a requirement that the UE has a valid Timing Advance (TA) and is uplink synchronized to be able to use the resources for transmission.

For Narrowband Internet of Things (NB-IoT) and Long Term Evolution-Machine Type Communication (LTE-M), similar signaling optimizations for small data have been introduced through Release 15 Early Data Transmission (EDT) and Release 16 Preconfigured Uplink Resources (PUR). The main differences for the New Radio (NR) Small Data Transmission (SDT) solutions are that the Release 17 NR Small Data is only to be supported for an RRC INACTIVE state, including also 2-step RACH based small data, that it is supported by any NR User Equipment (UE) (i.e. also Mobile Broadband (MBB) UEs and not limited to Internet of Things (IoT) UEs), and supporting transmission of subsequent data (i.e. larger payload sizes which require more than one transmission).

Long Term Evolution (LTE) support for mobile terminated data (MT) was later introduced in Release 16 and supports transmissions of small data payloads in the downlink (DL). Note that for NB-IoT and LTE-M different solutions were introduced for the IoT control-plane optimization (‘Data over Non-Access Stratum,’ or DoNAS) and IoT user-plane optimizations (RRC suspend/resume), Control Plane-Early Data Transmission (CP-EDT) and User Plane-Early Data Transmission (UP-EDT), respectively, and that the NR solutions resembles the UP-EDT.

Currently Mobile Terminated-Small Data Transmission (MT-SDT) is being introduced in Release 18 for NR. A Release 18 MT-SDT work item description (WID) was approved in RAN #94e (December 2021) and can be found in RP-213583. The WID contains the following objectives:
Specify the support for paging-triggered SDT (MT-SDT) [RAN2, RAN3]
   MT-SDT triggering mechanism for User Equipments (UEs) in RRC_INACTIVE, supporting RA-SDT and CG-SDT as the UL response;
   MT-SDT procedure for initial DL data reception and subsequent UL/DL data transmissions in RRC_INACTIVE.
Note: Data transmission in DL within paging message is not in scope of this [Work Item].

For MO-SDT in Release 17, a rough check on the radio environment was introduced, to ensure that MO-SDT was not performed in radio environments that would lead to too many retransmissions on a non-quality controlled link. This objective is to not end up in a situation that requires a lot of extra signaling in RRC_INACTIVE, since it would be more effective for the network to move the UE to RRC_CONNECTED instead. The nature of MO-SDT means that the check has to be done by the UE before it makes a random access (RA) attempt, and by then there exists no good estimation of the UL radio channel. The option chosen is to perform a measurement of the DL carrier's signal strength (i.e., Reference Signal Received Power (RSRP)) and use that as an estimation of the UL radio channel quality. Even though not perfect, it keeps the UE from attempting MO-SDT in the worst cases.

For MT-SDT, there will probably be a need to perform some estimations of the radio channel as well, and some discussions has been held to re-use the RSRP check as in MO-SDT.

In EDT procedures from Release 16, the triggering of a channel quality estimation was described.

There currently exist certain challenge(s), however. For example, Small Data Transmission (SDT) involves transmitting small amounts of data while the UE remains in INACTIVE state, and for RA-based MT-SDT, this feature allows data transmission during Message 4 of the initial access procedure. Currently, NR does not support link adaptation during initial access procedure, before the UE is sent to CONNECTED state. This implies that, with no knowledge of radio conditions, the gNodeB (gNB) needs to resort to transmissions under the assumption that the UE belongs to cell-edge, as shown in FIG. 1. This reduces spectral efficiency significantly.

### SUMMARY

Certain aspects of the disclosure and their embodiments may provide solutions to these or other challenges. For example, methods and systems are provided for early CQI reporting for MT-SDT such as, for example, in Msg3. According to certain embodiments, systems and methods enable the calculation of channel state information (CSI) by the gNB during a MT-SDT procedure.

According to certain embodiments, a method by a UE configured for MT-SDT for early CQI reporting is provided. The method includes receiving, before a RRC connection is established with a network node, information indicating at least one RS. The UE receives, from the network node, the at least one RS. Based on the at least one RS, the UE performs at least one CSI measurement. Before the RRC connection is established with the network node, the UE transmits, to the network node, CSI associated with the at least one CSI measurement.

According to certain embodiments, a UE configured for MT-SDT for early CQI reporting is configured to receive, before a RRC connection is established with a network node, information indicating at least one RS. The UE is configured to receive, from the network node, the at least one RS. Based on the at least one RS, the UE is configured to perform at least one CSI measurement. Before the RRC connection is established with the network node, the UE is configured to transmit, to the network node, CSI associated with the at least one CSI measurement.

According to certain embodiments, a method by a network node for CQI reporting for SDT is provided. The method includes transmitting, before a RRC connection is established with a UE configured for MT-SDT, information indicating at least one RS to the UE. The network node transmits the at least one RS to the UE. Before the RRC connection is established with the UE, the network node receives CSI from the UE, and the CSI is associated with at least one CSI measurement performed by the UE based on the at least one RS.

According to certain embodiments, a network node for CQI reporting for SDT is configured to transmit, before an RRC connection is established with a UE configured for MT-SDT, information indicating at least one RS to the UE. The network node is configured to transmit the at least one RS to the UE. Before the RRC connection is established with the UE, the network node is configured to receive CSI from the UE, and the CSI is associated with at least one CSI measurement performed by the UE based on the at least one RS.

Certain embodiments may provide one or more of the following technical advantage(s). For example, certain embodiments may provide a technical advantage of providing methods and systems for making calculation of CSI feasible and compatible for MT-SDT. Specifically, whereas previous techniques for SDT focus on a UE-centric solution where the gNB facilitates transmissions with the assumption that the UE belongs to cell-edge, certain embodiments disclosed herein may provide a technical advantage of enabling the gNB to estimate the channel state in a manner that allows a small data procedure to be network-centric instead. Enabling channel calculation during MT-SDT procedure allows better network usage with higher spectral efficiency.

As another example, certain embodiments may provide a technical advantage of allowing a gNB or other network node to make better decisions relating to, for example, whether to transmit the data to the UE as part of SDT procedure or bringing the UE to CONNECTED mode or even for facilitating better link adaptation capabilities.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a signaling diagram for data transmission during which a network node assumes that the UE is near a cell edge;

FIG. 2 illustrates an example communication system, according to certain embodiments;

FIG. 3 illustrates an example UE, according to certain embodiments;

FIG. 4 illustrates an example network node, according to certain embodiments;

FIG. 5 illustrates a block diagram of a host, according to certain embodiments;

FIG. 6 illustrates a virtualization environment in which functions implemented by some embodiments may be virtualized, according to certain embodiments;

FIG. 7 illustrates a host communicating via a network node with a UE over a partially wireless connection, according to certain embodiments;

FIG. 8 illustrates an example method by a UE for early CQI reporting for SDT, according to certain embodiments;

FIG. 9 illustrates an example method by a network node for early CQI reporting for MT-SDT, according to certain embodiments;

FIG. 10 illustrates another example method by a network node for early CQI reporting for SDT, according to certain embodiments;

FIG. 11 illustrates another example method by a UE configured for MT-SDT for early CQI reporting, according to certain embodiments; and

FIG. 12 illustrates another example method by a network node for early CQI reporting, according to certain embodiments.

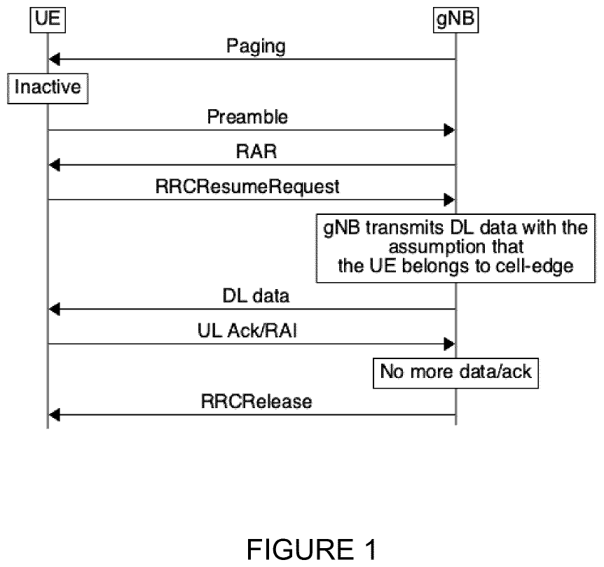

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of DL physical signals are reference signals (RS) such as Primary Synchronization Signal (PSS), Secondary Synchronization Signal (SSS), Channel State Information-Reference Signal (CSI-RS), Demodulation Reference Signal (DMRS) signals in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity such as, for example, 20 ms, 40 ms, etc. The RS may also be aperiodic. Each SSB carries NR-PSS, NR-SSS and NR-PBCH in 4 successive symbols. One or multiple SSBs are transmit in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's System Frame Number (SFN)), etc. Therefore, SMTC occasion may also occur with certain periodicity such as, for example, 5 ms, 10 ms, 20 ms, 40 ms, 80 ms, and 160 ms. Examples of UL physical signals are RS such as SRS, DMRS, etc. The term physical channel refers to any channel carrying higher layer information such as data, control, etc. Examples of physical channels are, Physical Broadcast Channel (PBCH), Narrowband PBCH (NPBCH), Physical Downlink Control Channel (PDCCH), Physical Downlink Shared Channel (PDSCH), Physical Uplink Shared Channel (PUSCH), Physical Uplink Control Channel (PUCCH), shortened PUCCH (sPUCCH), shortened PDSCH (sPDSCH), shortened PUCCH (sPUCCH), shortened PUSCH (sPUSCH), MTC PDCCH (MPDCCH), narrowband PDCCH (NPDCCH), narrowband PDSCH (NPDSCH), Enhanced PDCCH (E-PDCCH), narrowband PUSCH (NPUSCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, SFN cycle, hyper-SFN (H-SFN) cycle, etc.

In NR, CSI-RS can be used for DL link adaptation, setting Multiple Input Multiple Output (MIMO) parameters (e.g., number of MIMO layers or rank and precoding matrix), DL beam management, fine time-frequency tracking (using tracking reference signals (TRS)), Radio Resource Management (RRM) and Radio Link Monitoring (RLM) measurements, beam failure detection, and PDSCH rate matching (using the so-called zero-power CSI-RS, or Zero Power-CSI-RS (ZP-CSI-RS)).

For DL link adaptation, in particular, the CSI-RS is used by the UE to provide feedback on the desired Modulation Coding Scheme (MCS) to use for PDSCH transmission. This feedback is termed as channel quality indication (CQI).

Unless explicitly stated, as used herein, “CSI-RS” encompasses both ZP-CSI-RS (i.e., CSI-RS used for PDSCH rate matching) and Non-Zero Power CSI-RS (NZP-CSI-RS) (i.e., CSI-RS used for purposes other than PDSCH rate matching).

For measuring and reporting CSI based on CSI-RS and/or SSB resources, the UE is provided with measurement resource configurations, using the IE CSI-ResourceConfig, and measurement report configuration, using the IE CSI-ReportConfig.

The CSI-RS measurement configuration includes time and frequency domain locations, number of antenna ports, code division multiplexing types, CSI-RS density, CSI-RS bandwidth, and time-domain behavior (i.e., periodic, semi-persistent, or aperiodic). One CSI resource configuration includes one or more resource sets for NZP-CSI-RS and/or ZP CSI-RS and/or CSI-SSB.

The CSI report configuration includes what to report (i.e., the report quantity to use while reporting the CSI) and how to report (i.e., the time-domain behavior to use for reporting). The report quantity includes rank indication, precoding matrix indication, CQI, RSRP, or “none” (used for UE-side beam sweeping). The time-domain behavior for reporting configuration includes periodic on PUCCH, semi-persistent on PUCCH/PUSCH, and aperiodic on PUSCH.

The aperiodic NZP-CSI-RS is triggered by the CSI request field in the UL Downlink Control Information (DCI) (Format 0_1) that schedules PUSCH. This field points to one of the states in the list of aperiodic trigger states, given by the IE CSI-AperiodicTriggerStateList. Each trigger state within this list contains an associated report configuration, given by the IE CSI-AssociatedReportConfigInfo. The associated report configuration contains information related to CSI-RS/SSB measurement resources, as well as pointer to the reporting configuration.

In addition to the UL DCI, the CSI request field for aperiodic NZP-CSI-RS is also available in the Random Access Response (RAR) grant provided in Msg2. However, this 1-bit field is currently reserved.

On the other hand, the aperiodic ZP-CSI-RS is triggered by a field in the DL DCI (Format 1_1).

The CSI for interference measurements (CSI-IM) can be configured to measure interference to enable CSI feedback (e.g., CQI) that takes into account inter-cell interference (or intra-cell interference for Multi-User MIMO (MU-MIMO)). The CSI-IM resources can be configured similarly to the CSI-RS resources, as described above.

In legacy NR, the CSI feedback is provided by the UE to the network only after RRC connection has been established. Early CSI feedback during RA procedure can be useful to perform link adaptation, and therefore to ensure efficient data transmission without having to wait until connection establishment. For example, a CQI report in Msg3 helps the network to perform link adaptation for Msg4. The early CSI is especially useful for Release 18 MT-SDT as the UE typically remains in the RRC inactive state without moving to the RRC connected state. Therefore, the early CSI can be useful to perform link adaptation for Msg4 as well as for subsequent DL transmissions for MT-SDT (after Msg4).

Certain embodiments disclosed herein provide methods and systems for making calculation of CSI feasible and compatible for MT-SDT. Specifically, whereas previous techniques for SDT focus on a UE-centric solution where the gNB facilitates transmissions with the assumption that the UE belongs to cell-edge, certain embodiments disclosed herein may provide a technical advantage of enabling the gNB to estimate the channel state in a manner that allows a small data procedure to be network-centric instead. Enabling channel calculation during MT-SDT procedure allows better network usage with higher spectral efficiency.

According to certain embodiments, for example, methods and systems are provided for enabling a network node (e.g., gNB) to calculate CSI during a MT-SDT procedure. Various particular embodiments described below may relate to one or more of the following details:
Configuration of RS for determining the CSI.
Indication to the UE to inform which RS to use for the determination of CSI
Embodiments on triggering the RS
Timing offset modifications for reporting CSI in Message 3
Subsequent and Differential CSI

### Configuration of RS for Determining the CSI

In various particular embodiments, the information related to CSI measurement and report configuration can be provided to a UE configured with MT-SDT using one or more of the following methods:
(1) Within the RRCRelease message that is used to provide the MT-SDT configuration. The RRCRelease message may include the full measurement and report configuration or may include pointer(s) to the configuration that the UE has received before the release message.
(2) In a combination of the RRCRelease message and SIB1. That is, RRCRelease may contain only a part of the information and the rest is included in SIB1. For example, CSI report configuration is provided in the RRCRelease message, but the CSI resource configuration in SIB1. This minimizes the amount of information that needs to be broadcasted in SIB1.
(3) In a combination of the RRCRelease message and specification(s). That is, RRCRelease may contain part of the information and the rest is hard coded in the NR specification. For example, reporting quantity and time-domain behavior of the report configuration can be hard coded as cri-RI-CQI and aperiodic, respectively.
(4) In a combination between RRCRelease message and SIB or specification. In one example, the RRCRelease carries configurations (or part of configurations) that are valid if the UE accesses using CG-SDT resources and the configuration if the UE accesses using RA based procedures is carried in SIB or specification.
(5) Within the Paging message (PDSCH). The paging PDSCH may contain a common pointer to the resource and/or reporting configuration for all the UEs addressed in the paging message, or the pointer may be specific to one or a group of UEs addressed in the paging message. The pointer(s) may point to a resource/report configuration provided in the RRCRelease message and/or SIB1.
(6) Within a new SIB (e.g., SIB22). This new SIB contains CSI resource and report configurations for MT-SDT UEs.
   Indication to Inform the UE on which RS to Use to Determine the CSI

In another particular embodiment, the CSI measurement and determination of the corresponding the report quantity (e.g., CQI) can be based on one of the following RS:
DMRS for Paging (PDSCH) that initiates MT-SDT procedure
DMRS for Paging PDCCH

Additionally, the CSI measurement can be based on:
DMRS for Msg2 PDCCH or Msg2 PDSCH
CSI-RS or TRS
SSB

The above RS can also be used for CSI measurement and reporting for MT-SDT procedure.

From above, it can be seen that different types of RS can be used for CSI measurements.

In a particular embodiment, for example, an indication is provided to the UE to indicate which RS among the above can be used for CSI measurement during MT-SDT procedure. The indications can be provided in one or more of the following messages:
SIB1, in which case the indication is common to all MT-SDT UEs.
RRCRelease, in which case the indication is specific to an MT-SDT UE
   Additionally, the indication can also be included in the Message 2 PDSCH or in the DCI scrambled with RA-RNTI that schedules the Msg2 PDSCH, in which case the indication is specific to one or few UEs. However, in these cases, DMRS for Paging cannot be used to obtain the report quantity.

In a particular embodiment, the UE may use different resources depending on if it accesses using CG-SDT or random-access based methods. For example, DMRS for Msg2 PDCCH or Msg2 PDSCH cannot be used if the UE accesses using CG-SDT.

In a particular embodiment, it can be configured whether or not the UE should do CSI measurements and reporting if it initiates a CG-SDT procedure after being paged for MT-SDT. The UE is in this case stationary meaning that the RSRP is rather constant, but in some scenarios, the interference level may be expected to vary and impact the CQI.

### Triggering RS

In another embodiment, gNB triggers the transmission of a RS for CSI reporting at a certain step of the MT-SDT procedure. The RS can be CSI-RS or Non-Cell Defining-Synchronization Signal Block (NCD-SSB).

In various particular embodiments, the triggering step can be any one or more of the following:
When the UE responds with a preamble to the initial paging message, where the preamble can be either:
   legacy (non-SDT) RACH preamble
   specific Rel-17 SDT preamble
   specific Rel-18 MT-SDT preamble.
   CFRA (contention-free random access) preamble provided to the UE in paging.
In association of transmission Msg2 with Random Access Response message to any of the above preambles.
When gNB transmits MT-SDT paging such as, for example, when a paging message, which includes MT-SDT indication in paging message on PDSCH, is transmitted in the cell.
When gNB initiates MT-SDT procedure in the cell such as, for example, when gNB determines DL data for the UE is small enough that it is both possible and favorable.

In addition to the triggering of transmission of CSI-RS/NCD-SSB, the above steps can also be used to trigger CSI-IM resources for the purpose of interference measurement.

Additionally or alternatively, in particular embodiments, any CSI-based RS/CSI parameters including the CSI-RS or TRS transmission duration, or the CSI-IM duration, can be adopted to the MT-SDT procedure. That is gNB could trigger the transmission of CSI-RS according to any MT-SDT conditions above and continue transmission of CSI-RS until the MT-SDT procedure is terminated.

### Determination of CQI

The CQI report by the UE indicates a recommended MCS, determined by assuming a hypothetical PDSCH transmission on resources indicated by CSI resource configuration. Typically, CQI can be mapped to a signal-to-noise and interference ratio (SINR) value, which can then be used for link adaptation.

The SINR is defined as the linear average over the power contribution (in [W]) of the resource elements carrying RS divided by the linear average of the noise and interference power contribution (in [W]). That is:

$$SINR = \frac{RSRP}{Intereference + Noise}$$

See, 3GPP TS 38.215, NR; Physical layer measurements, 17.2.0, September 2022.

For SS-SINR (i.e., SINR based on secondary synchronization (SS) signals) and CSI-SINR, (i.e., SINR based on CSI-RS), the RSRP is calculated based on SS and CSI-RS, respectively. The interference and noise can be measured based on either dedicated interference measurement resources (e.g., CSI-Interference Management (CSI-IM)) indicated by higher layers, or over the same resource elements carrying the corresponding RS. See, id.

In a particular embodiment, as alternatives to SS-SINR and CSI-SINR described above, the RSRP and the noise and interference used for SINR calculation is based on one or more of the following RS:
DMRS for Paging (PDSCH) that initiates MT-SDT procedure
DMRS for Paging PDCCH.
DMRS for Msg2 PDCCH or Msg2 PDSCH
   This SINR can then be used as an input for determining CQI to be reported in Msg3 or in potential subsequent transmissions during the MT-SDT procedure.

### Subsequent and Differential CSI

Considering how long the CSI may be valid, especially in the case of subsequent transmissions, the following MT-SDT specific adaptations can be considered.

### Subsequent CSI RS and Triggering

In a particular embodiment, the transmission of RS for CSI measurements can be semi-persistent. For example, after a RS has been triggered, the RS continue to be transmitted until the final MT-SDT subsequent transmission has been sent and the UE is notified through the RRCRelease message. Triggering semi-persistent RS can be done based on one of the embodiments mentioned in herein. In another alternative, this can be triggered by the network by sending a legacy/new MAC CE.

Alternatively, in a particular embodiment, the transmission of reference signals may be on a periodic basis. For example, CSI-RS or NCD-SSB for MT-SDT could be transmitted periodically while a specified timer is running or until a certain step of the MT-SDT procedure (e.g., until the CSI report is received in Msg3). Alternatively, in a particular embodiment, no RS is specifically configured and any subsequent reporting can be based on the DMRS sent along with a previous PDCCH/PDSCH transmissions. In another example, the RSs are transmitted periodically matching the CG-SDT periodicity.

As still another alternative, in a particular embodiment, there can be subsequent CSI RS triggered even aperiodically. However, as described above, the aperiodic CSI-RS is triggered using UL DCI (Format 0_1) for NZP-CSI-RS and using DL DCI (Format 1_1) for ZP-CSI-RS. However, Format 0_1 and Format 1_1 (which are commonly known as non-fallback DCI formats) are not applicable in an initial Bandwidth part (BWP), which is where MT-SDT procedure is carried out. In order to solve this issue, in a particular embodiment, non-fallback DCI formats are configured to a UE during MT-SDT procedure in an initial BWP. The configuration related to non-fallback DCI formats can be provided in a DL message (e.g., in Message 4) transmitted during the MT-SDT procedure, or within the RRCRelease message that is used to provide the MT-SDT configuration.

### Subsequent CSI Reporting

Subsequent CSI reporting supports CSI reports based on the above RS (e.g., CSI-RS or NCD-SSB) to be transmitted periodically in the cell until the MT-SDT procedure is terminated. This allows for the MT-SDT UE not only to include a CSI report in Msg3, but also include updated reports multiplexed with the acknowledgement in uplink (in PUCCH or PUSCH) to the initial downlink data transmission in Msg4 and also to the subsequent downlink data transmissions. The subsequent CSI reports can be of the same format as the initial report in Msg3.

### Differential CSI Reporting

As an alternative to the absolute (full) reports, relative/differential CSI reports may be provided where the UE continues to indicate any changes in the quality of the channel, applicable for Message 3 or subsequent transmissions. Differential CSI aims to indicate the difference in the present channel conditions with respect to the previously reported channel quality.

For differential CSI in Message 3, the reference baseline (i.e., the previously reported channel quantity) can be configured during RRCRelease. For example, this can be a quantity derived based on monitoring the current RSRP changes when compared with the RSRP configured during RRCRelease. For subsequent transmissions, the reference baseline can be the CSI reported any time before the subsequent transmissions are initiated. In another alternative, differential CSI is reported only for the subsequent transmissions (and absolute CSI is reported in Msg3).

In one alternative, the differential CSI is calculated by deriving a quantity based on differential Layer 1-RSRP with respect to the reported power of the RS on which the interference is measured. For example, here the new differential CSI can be defined as

New CSI=current CSI−previous CSI

For example, the differential SINR (that can be used as an input to CQI calculation) can be determined as follows:

$$New differential SINR = current ( RSRP / Noise + Interference ) - previous ( RSRP / Noise + Interference )$$

### Configuration and Triggering of SRS

The embodiments related to configuration and triggering of RS has been exemplified using DL RS (e.g., CSI-RS, DMRS, SSB, etc.). In a particular embodiment, as an alternative to DL RS, the UE may be triggered to transmit SRS (in the UL). The received SRS can be used by the gNB to estimate radio channel conditions in the DL (assuming channel reciprocity exists), and thereby perform link adaptation for MT-SDT transmissions in the DL. The configuration principle of SRS can be similar to as described above, for example, configuration of SRS can be provided to a UE configured with MT-SDT using one or more of the methods described above.

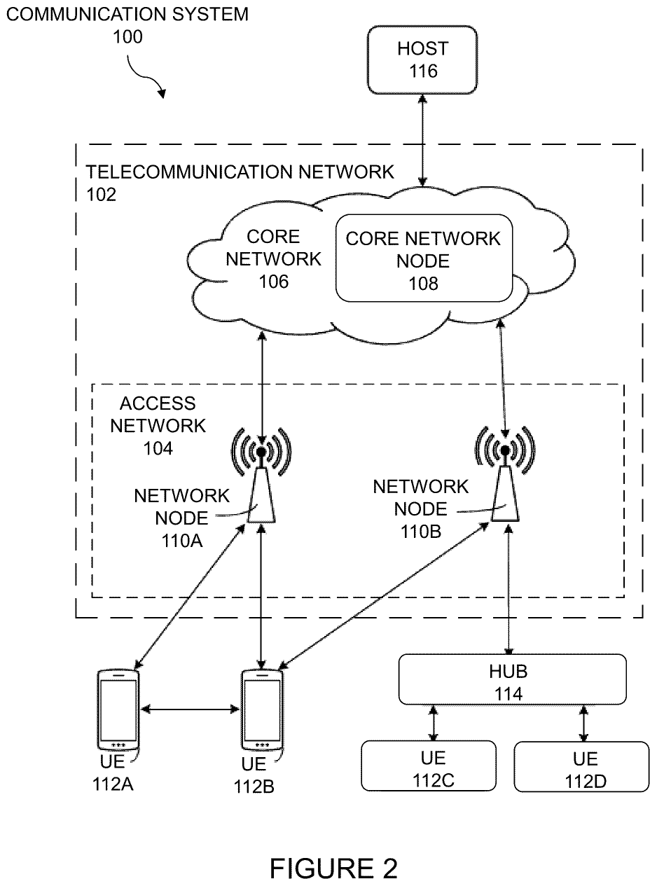

FIG. 2 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

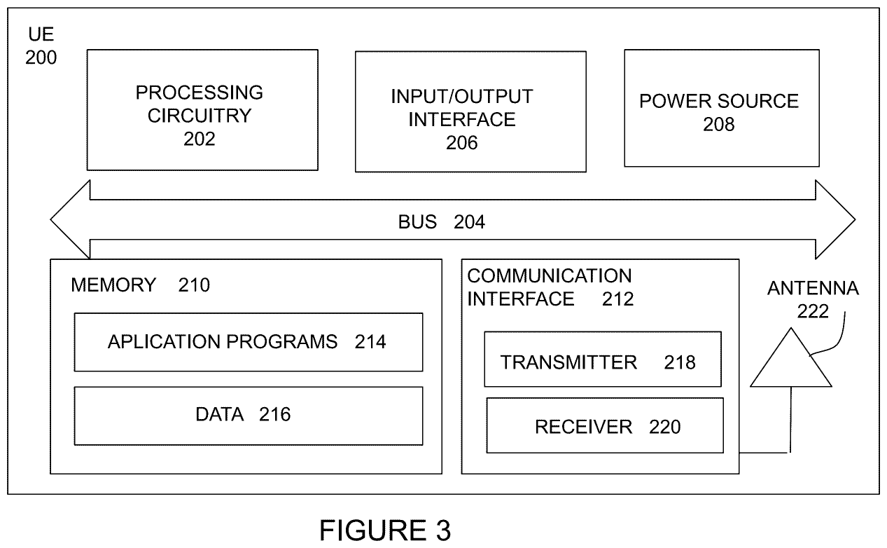

FIG. 3 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

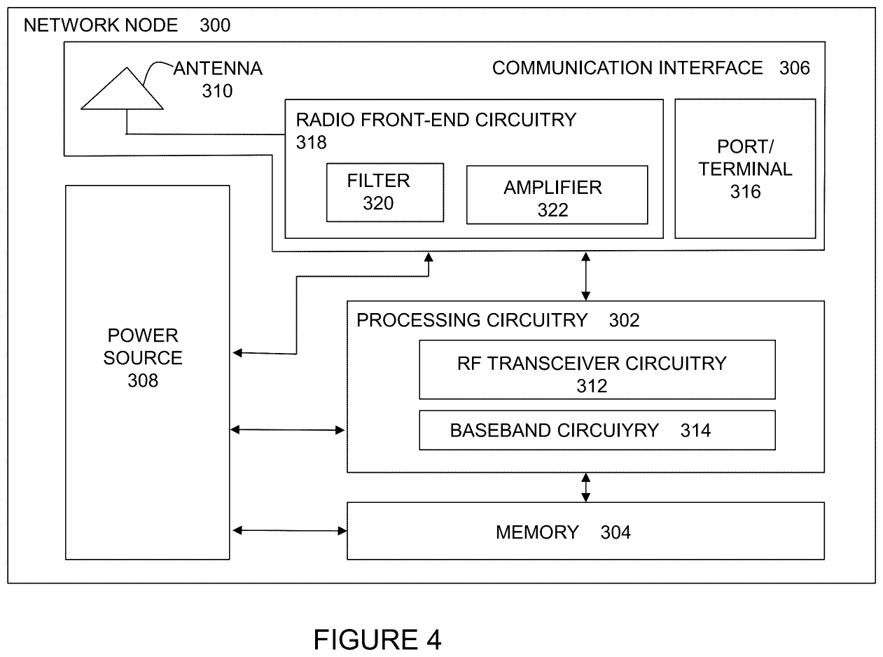

FIG. 4 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 4 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

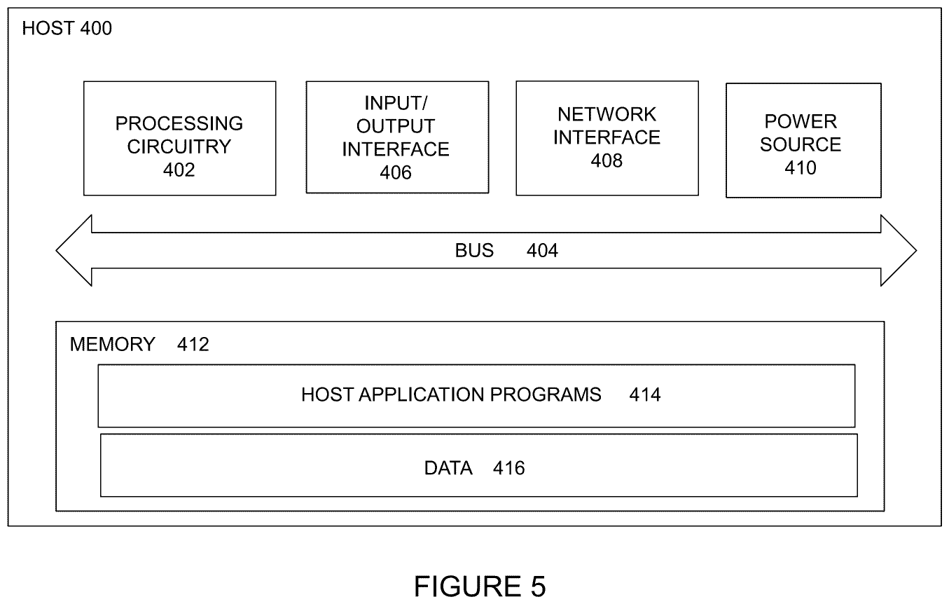

FIG. 5 is a block diagram of a host 400, which may be an embodiment of the host 116 of FIG. 2, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

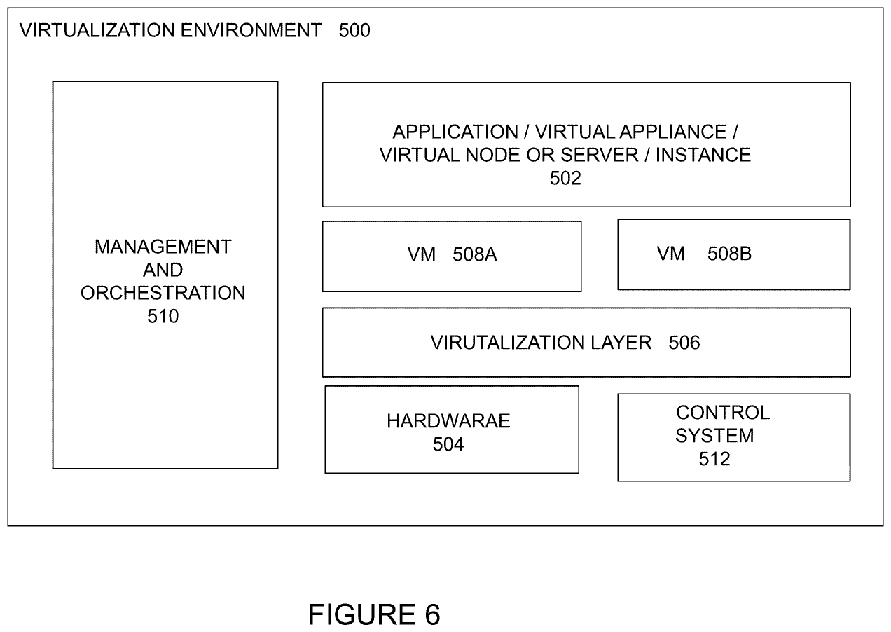

FIG. 6 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

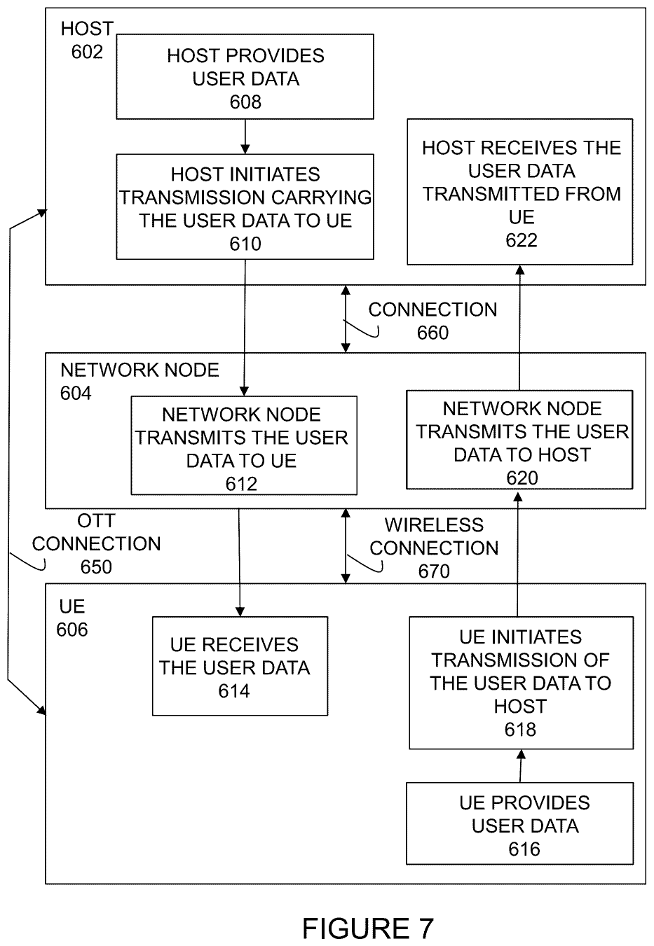

FIG. 7 shows a communication diagram of a host 602 communicating via a network node 604 with a UE 606 over a partially wireless connection in accordance with some embodiments.

Example implementations, in accordance with various embodiments, of the UE (such as a UE 112a of FIG. 2 and/or UE 200 of FIG. 3), network node (such as network node 110a of FIG. 2 and/or network node 300 of FIG. 4), and host (such as host 116 of FIG. 2 and/or host 400 of FIG. 5) discussed in the preceding paragraphs will now be described with reference to FIG. 7.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

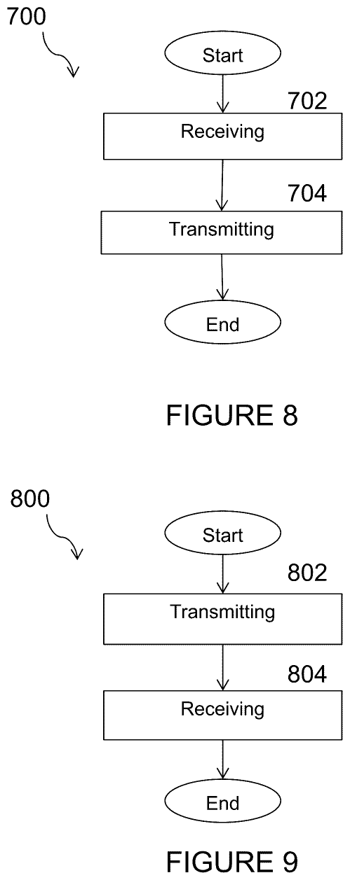

FIG. 8 illustrates an example method 700 by a UE 112 for early CQI reporting for SDT, according to certain embodiments. In the illustrated embodiment, the method includes at least one of a receiving step at 702 and/or a transmitting step at 704.

For example, in a particular embodiment, at step 702, the UE 112 may receive, from a network node 110, information indicating to perform, at least one channel state and/or quality measurement and/or transmit CSI before a RRC connection is established. At step 704, for example, the UE 112 may transmit, to the network node 110, the CSI before the RRC connection is established.

As another example, in a particular embodiment, at step 702, the UE 112 may receive, form the network node 110, information indicating to transmit at least one RS before a RRC connection is established. At step 904, for example, the UE 112 may transmit, to the network node 110, the at least one RS before the RRC connection is established.

FIG. 9 illustrates an example method 800 by a network node 110 for early CQI reporting for MT-SDT, according to certain embodiments. In the illustrated embodiment, the method includes at least one of a transmitting step at 802 and/or a receiving step at 804. For example, at step 802, the network node 110 may transmit, to a UE 112, information indicating for the UE 112 to perform at least one channel state and/or quality measurement and/or transmit CSI before a RRC connection is established. At step 804, for example, the network node 110 may receive, from the UE 112, the CSI before the RRC connection is established.

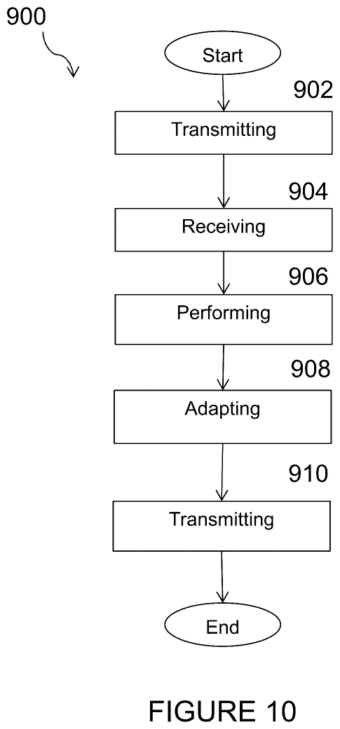

FIG. 10 illustrates another example method 900 by a network node 110 for early CQI reporting for SDT, according to certain embodiments. In the illustrated embodiment, the method includes at least one of a transmitting step at 902, a receiving step at 904, a performing step at 906, an adapting step at 908, and a transmitting step at 910. For example, at step 902, the network node 110 may transmit, to a UE 112, information indicating to transmit at least one RS before a RRC connection is established. As another example, at step 904, the network node 110 may receive, from the UE 112, the at least one RS before the RRC connection is established. As another example, at step 906, the network node 110 may perform at least one channel state and/or quality measurement and/or transmit CSI based on the at least one RS. As yet another example, at step 908, the network node 110 may adapt a downlink channel for at least one transmission to the UE 112 based on the at least one channel state and/or quality measurement. As yet another example, at step 910, the network node 110 may transmit, to the UE 112, the CSI before the RRC connection is established.

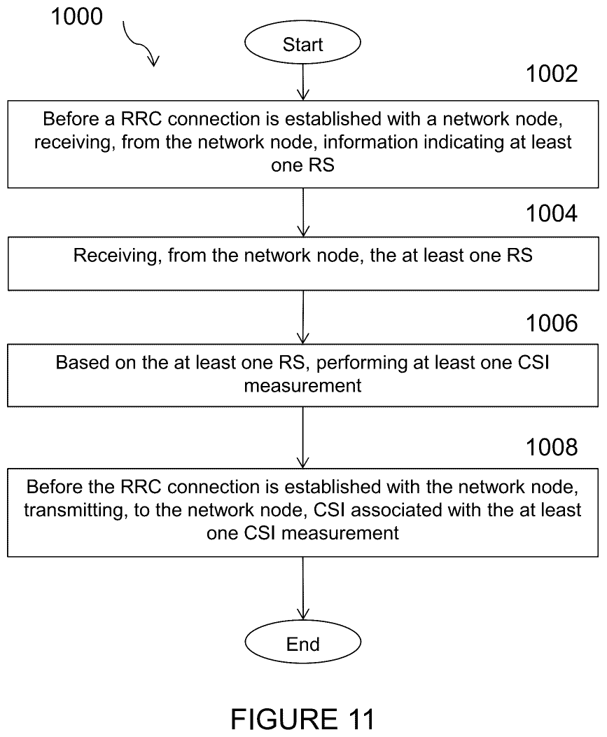

FIG. 11 illustrates another example method 1000 by a UE 112 configured for MT-SDT for early CQI reporting, according to certain embodiments. As depicted the method begins at step 1002 when, before a RRC connection is established with a network node 110, the UE 112 receives, from the network node, information indicating at least one RS. At step 1004, the UE 112 receives the at least one RS from the network node. Based on the at least one RS, the UE performs at least one CSI measurement, at step 1006. Before the RRC connection is established with the network node, the UE 112 transmits, to the network node 110, CSI associated with the at least one CSI measurement, at step 1008.

In a particular embodiment, the at least one a CSI measurement is used for MT-SDT.

In a particular embodiment, the UE 112 receives a plurality of RS, and the UE is configured for at least one of: periodic CSI reporting, aperiodic CSI reporting, semipersistent CSI reporting, and differential CSI reporting.

In a particular embodiment, the at least one RS comprises at least one of: at least one DMRS for paging on a PDSCH; at least one DMRS for paging on a PDCCH; at least one DMRS for a Msg2 PDCCH or a Msg2 PDSCH; at least one CSI-RS; at least one NCD-SSB; at least one CSI-IM RS; at least one TRS; and at least one SSB.

In a particular embodiment, the UE 112 transmits the CSI via a SDT.

In a particular embodiment, the information received from the network node 110 comprises a CSI measurement and report configuration.

In a particular embodiment, the information is received in at least one of: a RRCRelease message; a SIB message; a paging message; a Msg2 PDCCH; a Msg2 PDSCH; DCI; and a SIB.

In a particular embodiment, prior to receiving the information from the network node 110, the UE 112 transmits, to the network node 110, a Msg1 in a 4-step Random Access, RA, procedure or a MsgA in a 2-step RA procedure. The Msg1 or MsgA includes at least one of: a RACH preamble, a Rel-17 SDT preamble, a Rel-18 MT-SDT preamble, and a CFRA preamble.

In a particular embodiment, the UE 112 transmits the CSI in a Msg3 in a 4-step Random Access, RA, procedure or a MsgB in a 2-step RA procedure.

In a particular embodiment, the UE 112 transmits the CSI in an uplink message that acknowledges a previous transmission from the network node 110. The uplink message includes: an uplink PUCCH message that acknowledges a Msg4 in a 4-step RA procedure; an uplink PUSCH message that acknowledges a Msg4 in a 4-step RA procedure; an uplink PUCCH message that acknowledges a MsgB in a 2-step RA procedure; or an uplink PUSCH message that acknowledges a MsgB in a 2-step RA procedure.

In a particular embodiment, the information received from the network node 110 includes a CQI.

In a particular embodiment, the UE 112 is configured for CG-SDT, and/or the at least one CSI measurement comprises a CG-SDT measurement.

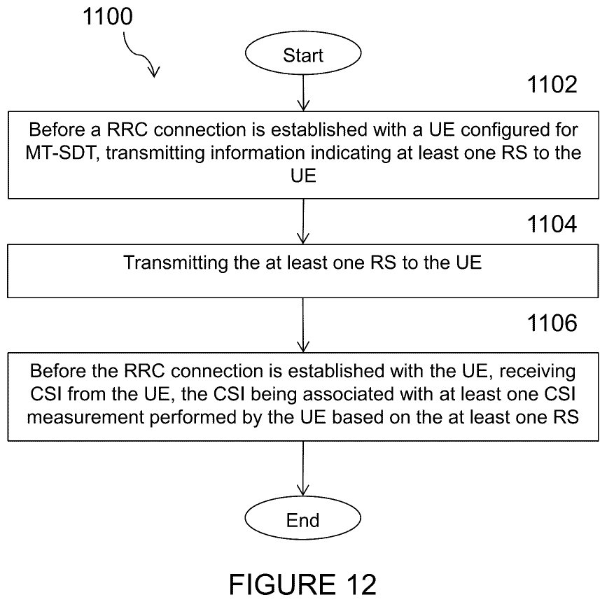

FIG. 12 illustrates another method 1100 by a network node 110 for early CQI reporting for SDT, according to certain embodiments. As illustrated, the method begins at step 1102 when, before a RRC connection is established with a UE 112 configured for MT-SDT, the network node 110 transmits information indicating at least one RS to the UE. At step 1104, the network node 110 transmits the at least one RS to the UE 112. Before the RRC connection is established with the UE 112, the network node 110 receives CSI from the UE, at step 1106. The CSI is associated with at least one CSI measurement performed by the UE based on the at least one RS.

In a particular embodiment, the at least one CSI measurement is used for MT-SDT.

In a particular embodiment, the network node 110 transmits a plurality of RS, and the UE is configured for at least one of: periodic CSI reporting, aperiodic CSI reporting, semipersistent CSI reporting, and differential CSI reporting.

In a particular embodiment, the at least one RS comprises at least one of: at least one DMRS for paging on a PDSCH; at least one DMRS for paging on a PDCCH; at least one DMRS for a Msg2 PDCCH or a Msg2 PDSCH; at least one CSI-RS; at least one NCD-SSB; at least one CSI-IM RS; at least one TRS; and at least one SSB.

In a particular embodiment, the network node 110 receives the CSI via a SDT.

In a particular embodiment, the information transmitted to the UE 112 includes a CSI measurement and report configuration.

In a particular embodiment, the information is transmitted to the UE in at least one of: a RRCRelease message; a SIB message; a paging message; a Msg2 PDCCH; a Msg2 PDSCH; DCI; and a SIB.

In a particular embodiment, prior to transmitting the information to the UE 112, the network node 110 receives from the UE 112, a Msg1 in a 4-step RA procedure or a MsgB in a 2-step RA procedure. The Msg1 or the MsgA comprises at least one of: a RACH preamble, a Rel-17 SDT preamble, a Rel-18 MT-SDT preamble, and a CFRA preamble.

In a particular embodiment, the network node 110 receives the CSI in: a Msg3 in a 4-step Random Access, RA, procedure; or a MsgB in a 2-step RA procedure.

In a particular embodiment, the network node 110 receives the CSI in an uplink message that acknowledges a previous transmission from the network node. The uplink message includes: an uplink PUCCH message that acknowledges a Msg4 in a 4-step RA procedure; an uplink PUSCH message that acknowledges a Msg4 in a 4-step RA procedure; an uplink PUCCH message that acknowledges a MsgB in a 2-step RA procedure; or an uplink PUSCH message that acknowledges a MsgB in a 2-step RA procedure.

In a particular embodiment, the information transmitted to the UE 112 comprises a CQI.

In a particular embodiment, the UE 112 is configured for CG-SDT and/or the at least one measurement comprises a CG-SDT measurement.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for early CQI reporting for MT-SDT, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for early CQI reporting for MT-SDT, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a UE for early CQI reporting for SDT, the method comprising at least one of: receiving, from a network node, information indicating to perform, at least one channel state and/or quality measurement and/or transmit CSI before a RRC connection is established; and transmitting, to the network node, the CSI before the RRC connection is established.

Example Embodiment C2. The method of Example Embodiment C1, wherein the information comprises a CSI measurement and report configuration.

Example Embodiment C3. The method of any one of Example Embodiments C1 to C2, wherein the information indicates at least one RS for the at least one channel state and/or quality measurement.

Example Embodiment C4. The method of Example Embodiment C3, comprising: receiving the at least one RS; and performing the at least one channel state and/or quality measurement based on the at least one RS.

Example Embodiment C5. The method of any one of Example Embodiments C3 to C4, wherein receiving the at least one RS comprises receiving a plurality of periodic RS, and wherein the UE is configured for periodic CSI reporting.

Example Embodiment C6. The method of any one of Example Embodiments C3 to C4, wherein receiving the at least one RS comprises receiving a plurality of RS, and wherein the UE is configured for aperiodic CSI reporting.

Example Embodiment C7. The method of any one of Example Embodiments C3 to C4, wherein receiving the at least one RS comprises receiving a plurality of RS, and wherein the UE is configured for semipersistent CSI reporting.

Example Embodiment C8. The method of any one of Example Embodiments C3 to C4, wherein receiving the at least one RS comprises receiving a plurality of RS, and wherein the UE is configured for differential CSI reporting.

Example Embodiment C9. The method of any one of Example Embodiments C3 to C8, wherein the at least one RS comprises at least one of: at least one DMRS for paging on a PDSCH; at least one DMRS for paging on a PDCCH; at least one DMRS for a Msg2 PDCCH or a Msg2 PDSCH; at least one CSI-RS; at least one NCD-SSB; at least one CSI-IM RS; at least one TRS; and at least one SSB.

Example Embodiment C10. The method of any one of Example Embodiments C1 to C9, wherein transmitting the CSI comprises transmitting the CSI via a SDT.

Example Embodiment C11. The method of any one of Example Embodiments C1 to C10, wherein transmitting the CSI to the network node before the RRC connection is established comprises transmitting the CSI in at least one of: a Msg3 in a 4-step RA procedure; an uplink PUCCH message that acknowledges a Msg4 in a 4-step RA procedure; an uplink PUSCH message that acknowledges a Msg4 in a 4-step RA procedure; an uplink PUCCH message that acknowledges a MsgB in a 2-step RA procedure; and an uplink PUSCH message that acknowledges a MsgB in a 2-step RA procedure.

Example Embodiment C12. The method of any one of Example Embodiments C1 to C11, wherein the information received from the network node comprises a CQI.

Example Embodiment C13. The method of any one of Example Embodiments C1 to C12, wherein the UE is configured for MT-SDT and/or wherein the at least one measurement comprises a MT-SDT measurement.

Example Embodiment C14. The method of any one of Example Embodiments C1 to C13, wherein the UE is configured for CG-SDT and/or wherein the at least one measurement comprises a CG-SDT measurement.

Example Embodiment C15. The method of any one of Example Embodiments C1 to C14, wherein the information is received in at least one of: a RRCRelease message; a SIB1 or another SIB message; a paging message; a Msg2 PDCCH; a Msg2 PDSCH; DCI; and a SIB comprising at least a CSI resource and a report configuration.

Example Embodiment C16. The method of any one of Example Embodiments C1 to C15, wherein prior to receiving the information from the network node, the method comprises transmitting at least one of: a RACH preamble, a Rel-17 SDT preamble, a Rel-18 MT-SDT preamble, and a CFRA preamble.

Example Embodiment C17. The method of any one of Example Embodiments C1 to C16, wherein the CSI transmitted by the UE comprises at least one of: a recommended MCS; at least one SINR value; at least one CSI-SINR value; at least one SS-SINR value; at least one RSRP value; and at least one CSI-IM value.

Example Embodiment C18. The method of any one of Example Embodiments C1 to C17, wherein performing the at least one channel state and/or quality measurement comprises performing at least one of: at least one SINR measurement; at least one CSI-SINR measurement; at least one SS-SINR value; at least one RSRP measurement; and at least one CSI-IM measurement.

Example Embodiment C19. The method of Example Embodiments C1 to C18, further comprising: providing user data; and forwarding the user data to a host via the transmission to the network node.

Example Embodiment C20. A user equipment comprising processing circuitry configured to perform any of the methods of Example Embodiments C1 to C19.

Example Embodiment C21. A user equipment configured to or adapted to perform any of the methods of Example Embodiments C1 to C19.

Example Embodiment C22. A wireless device comprising processing circuitry configured to perform any of the methods of Example Embodiments C1 to C19.

Example Embodiment C23. A computer program comprising instructions which when executed on a computer perform any of the methods of Example Embodiments C1 to C9.

Example Embodiment C24. A computer program product comprising computer program, the computer program comprising instructions which when executed on a computer perform any of the methods of Example Embodiments C1 to C19.

Example Embodiment C25. A non-transitory computer readable medium storing instructions which when executed by a computer perform any of the methods of Example Embodiments C1 to C19.

### Group D Example Embodiments

Example Embodiment D1. A method by a network node for early CQI reporting for SDT, the method comprising at least one of: transmitting, to a UE, information indicating for the UE to perform, at least one channel state and/or quality measurement and/or transmit CSI before a RRC connection is established; and receiving, from the UE, the CSI before the RRC connection is established.

Example Embodiment D2. The method of Example Embodiment D1, wherein the information comprises a CSI measurement and report configuration.

Example Embodiment D3. The method of any one of Example Embodiments D1 to D2, wherein the information indicates at least one RS for the at least one channel state and/or quality measurement.

Example Embodiment D4. The method of Example Embodiment D3, comprising transmitting, to the UE, the at least one RS to trigger the UE to perform the at least one channel state and/or quality measurement based on the at least one RS.

Example Embodiment D5. The method of any one of Example Embodiments D3 to D4, wherein transmitting the at least one RS comprises transmitting a plurality of periodic RS, and wherein the UE is configured for periodic CSI reporting.

Example Embodiment D6. The method of any one of Example Embodiments D3 to D4, wherein transmitting the at least one RS comprises transmitting a plurality of RS, and wherein the UE is configured for aperiodic CSI reporting.

Example Embodiment D7. The method of any one of Example Embodiments D3 to D4, wherein transmitting the at least one RS comprises transmitting a plurality of RS, and wherein the UE is configured for semipersistent CSI reporting.

Example Embodiment D8. The method of any one of Example Embodiments D3 to D4, wherein transmitting the at least one RS comprises transmitting a plurality of RS, and wherein the UE is configured for differential CSI reporting.

Example Embodiment D9. The method of any one of Example Embodiments D3 to D8, wherein the at least one RS comprises at least one of: at least one DMRS for paging on a PDSCH; at least one DMRS for paging on a PDCCH; at least one DMRS for a Msg2 PDCCH or a Msg2 PDSCH; at least one CSI-RS; at least one NCD-SSB; at least one CSI-IM RS; at least one TRS; and at least one SSB.

Example Embodiment D10. The method of any one of Example Embodiments D1 to D9, wherein receiving the CSI comprises receiving the CSI via a SDT.

Example Embodiment D11. The method of any one of Example Embodiments D1 to D10, wherein receiving the CSI to the network node before the RRC connection is established comprises receiving the CSI in at least one of: a Msg3 in a 4-step RA procedure; an uplink PUCCH message that acknowledges a Msg4 in a 4-step RA procedure; an uplink PUSCH message that acknowledges a Msg4 in a 4-step RA procedure; an uplink PUCCH message that acknowledges a MsgB in a 2-step RA procedure; and an uplink PUSCH message that acknowledges a MsgB in a 2-step RA procedure.

Example Embodiment D12. The method of any one of Example Embodiments D1 to D11, wherein the information transmitted to the UE comprises a CQI.

Example Embodiment D13. The method of any one of Example Embodiments D1 to D12, wherein the UE is configured for MT-SDT and/or wherein the at least one measurement comprises a MT-SDT measurement.

Example Embodiment D14. The method of any one of Example Embodiments D1 to D13, wherein the UE is configured for CG-SDT and/or wherein the at least one measurement comprises a CG-SDT measurement.

Example Embodiment D15. The method of any one of Example Embodiments D1 to D14, wherein the information is transmitted to the UE in at least one of: a RRCRelease message; a SIB1 or another SIB message; a paging message; a Msg2 PDCCH; a Msg2 PDSCH; DCI; and a SIB comprising at least a CSI resource and a report configuration.

Example Embodiment D16. The method of any one of Example Embodiments D1 to D15, wherein, prior to transmitting the information to the UE, the method comprises receiving from the UE at least one of: a RACH preamble, a Rel-17 SDT preamble, a Rel-18 MT-SDT preamble, and a CFRA preamble.

Example Embodiment D17. The method of any one of Example Embodiments D1 to D16, wherein the CSI comprises at least one of: a recommended MCS; at least one SINR value; at least one CSI-SINR value; at least one SS-SINR value; at least one RSRP value; and at least one CSI-IM value.

Example Embodiment D18. The method of any one of Example Embodiments D1 to D17, wherein the network node comprises a gNB.

Example Embodiment D19. The method of any one of Example Embodiments D1 to D18, further comprising: obtaining user data; and forwarding the user data to a host or a user equipment.

Example Embodiment D20. A network node comprising processing circuitry configured to perform any of the methods of Example Embodiments D1 to D19.

Example Embodiment D21. A network node configured to or adapted to perform any of the methods of Example Embodiments D1 to D19.

Example Embodiment D22. A computer program comprising instructions which when executed on a computer perform any of the methods of Example Embodiments D1 to D19.

Example Embodiment D23. A computer program product comprising computer program, the computer program comprising instructions which when executed on a computer perform any of the methods of Example Embodiments D1 to D19.

Example Embodiment D24. A non-transitory computer readable medium storing instructions which when executed by a computer perform any of the methods of Example Embodiments D1 to D19.

### Group E Example Embodiments

Example Embodiment E1. A method by a UE for early CQI reporting for SDT, the method comprising at least one of: receiving, from a network node, information indicating to transmit at least one RS before a RRC connection is established; and transmitting, to the network node, the at least one RS before the RRC connection is established.

Example Embodiment E2. The method of Example Embodiment E1, wherein the information comprises a RS configuration.

Example Embodiment E3. The method of any one of Example Embodiments E1 to E2, wherein the at least one RS comprises at least one SRS.

Example Embodiment E4. The method of any one of Example Embodiments E1 to E3, comprising receiving at least one SDT on a downlink channel.

Example Embodiment E5. The method of any one of Example Embodiments E1 to E4, comprising receiving CSI from the network node, the CSI based on the at least one RS transmitted before the RRC connection is established.

Example Embodiment E6. The method of Example Embodiment E5, wherein the CSI received from the network node comprises at least one of: a recommended MCS; at least one SINR value; at least one CSI-SINR value; at least one SS-SINR value; at least one RSRP value; and at least one CSI-IM value.

Example Embodiment E7. The method of any one of Example Embodiments E1 to E6, wherein the UE is configured for MT-SDT.

Example Embodiment E8. The method of any one of Example Embodiments E1 to E7, wherein the UE is configured for CG-SDT.

Example Embodiment E9. The method of any one of Example Embodiments E1 to E8, wherein the information is received in at least one of: a RRCRelease message; a SIB1 or another SIB message; a paging message; a Msg2 PDCCH; a Msg2 PDSCH; DCI; and a SIB comprising at least a CSI resource and a report configuration.

Example Embodiment E10. The method of any one of Example Embodiments E1 to E9, wherein prior to receiving the information from the network node, the method comprises transmitting at least one of: a RACH preamble, a Rel-17 SDT preamble, a Rel-18 MT-SDT preamble, and a CFRA preamble.

Example Embodiment E11. The method of Example Embodiments E1 to E10, further comprising: providing user data; and forwarding the user data to a host via the transmission to the network node.

Example Embodiment E12. A user equipment comprising processing circuitry configured to perform any of the methods of Example Embodiments E1 to E11.

Example Embodiment E13. A user equipment configured to or adapted to perform any of the methods of Example Embodiments E1 to E11.

Example Embodiment E14. A wireless device comprising processing circuitry configured to perform any of the methods of Example Embodiments E1 to E11.

Example Embodiment E15. A computer program comprising instructions which when executed on a computer perform any of the methods of Example Embodiments E1 to E11.

Example Embodiment E16. A computer program product comprising computer program, the computer program comprising instructions which when executed on a computer perform any of the methods of Example Embodiments E1 to E11.

Example Embodiment E17. A non-transitory computer readable medium storing instructions which when executed by a computer perform any of the methods of Example Embodiments E1 to E11.

### Group F Example Embodiments

Example Embodiment F1. A method by a network node for early CQI reporting for SDT, the method comprising at least one of: transmitting, to a UE, information indicating to transmit at least one RS before a RRC connection is established; receiving, from the UE, the at least one RS before the RRC connection is established; and performing at least one channel state and/or quality measurement and/or transmit CSI based on the at least one RS; adapting a downlink channel for at least one transmission to the UE based on the at least one channel state and/or quality measurement; and transmitting, to the UE, the CSI before the RRC connection is established.

Example Embodiment F2. The method of Example Embodiment F1, wherein the information comprises a RS configuration.

Example Embodiment F3. The method of any one of Example Embodiments F1 to F2, comprising: receiving the at least one RS from the UE; and performing the at least one channel state and/or quality measurement based on the at least one RS.

Example Embodiment F4. The method of Example Embodiment F3, wherein receiving the at least one RS comprises receiving a plurality of RS.

Example Embodiment F5. The method of any one of Example Embodiments F1 to F4, wherein the at least one RS comprises at least one SRS.

Example Embodiment F6. The method of any one of Example Embodiments F1 to F5, comprising configuring the UE for SDT.

Example Embodiment F7. The method of any one of Example Embodiments F1 to F6, wherein transmitting the CSI to the UE comprises transmitting the CSI in at least one of: a Msg4 in a 4-step RA procedure; a MsgB in a 2-step RA procedure; and an downlink PDCCH message.

Example Embodiment F8. The method of any one of Example Embodiments F1 to F7, wherein the UE is configured for MT-SDT.

Example Embodiment F9. The method of any one of Example Embodiments F1 to F8, wherein the UE is configured for CG-SDT.

Example Embodiment F10. The method of any one of Example Embodiments F1 to F9, wherein the information is transmitted in at least one of: a RRCRelease message; a SIB1 or another SIB message; a paging message; a Msg2 PDCCH; a Msg2 PDSCH; DCI; and a SIB comprising at least a CSI resource and a report configuration.

Example Embodiment F11. The method of any one of Example Embodiments F1 to F10, wherein prior to transmitting the information to the UE, the method comprises receiving form the UE at least one of: a RACH preamble, a Rel-17 SDT preamble, a Rel-18 MT-SDT preamble, and a CFRA preamble.

Example Embodiment F12. The method of any one of Example Embodiments F1 to F11, wherein the CSI transmitted to the UE comprises at least one of: a recommended MCS; at least one SINR value; at least one CSI-SINR value; at least one SS-SINR value; at least one RSRP value; and at least one CSI-IM value.

Example Embodiment F13. The method of any one of Example Embodiments F1 to F12, wherein performing the at least one channel state and/or quality measurement comprises performing at least one of: at least one SINR measurement; at least one CSI-SINR measurement; at least one SS-SINR value; at least one RSRP measurement; and at least one CSI-IM measurement.

Example Embodiment F14. The method of any one of Example Embodiments F1 to F13, wherein the network node comprises a gNB.

Example Embodiment F15. The method of any one of Example Embodiments F1 to F14, further comprising: obtaining user data; and forwarding the user data to a host or a user equipment.

Example Embodiment F16. A network node comprising processing circuitry configured to perform any of the methods of Example Embodiments F1 to F15.

Example Embodiment F17. A network node configured to or adapted to perform any of the methods of Example Embodiments F1 to F15.

Example Embodiment F18. A computer program comprising instructions which when executed on a computer perform any of the methods of Example Embodiments F1 to F1.

Example Embodiment F19. A computer program product comprising computer program, the computer program comprising instructions which when executed on a computer perform any of the methods of Example Embodiments F1 to F15.

Example Embodiment F20. A non-transitory computer readable medium storing instructions which when executed by a computer perform any of the methods of Example Embodiments F1 to F15.

### Group G Example Embodiments

Example Embodiment G1. A user equipment for early CQI reporting for MT-SDT, the UE comprising: processing circuitry configured to perform any of the steps of any of the Group A, C, and E Example Embodiments; and power supply circuitry configured to supply power to the processing circuitry.

Example Embodiment G2. A network node for early CQI reporting for MT-SDT, the network node comprising: processing circuitry configured to perform any of the steps of any of the Group B, D, and F Example Embodiments; power supply circuitry configured to supply power to the processing circuitry.

Example Embodiment G3. A UE for early CQI reporting for MT-SDT, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A, C, and E Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment G4. A host configured to operate in a communication system to provide an OTT service, the host comprising: processing circuitry configured to provide user data; and a network interface configured to initiate transmission of the user data to a cellular network for transmission to a UE, wherein the UE comprises a communication interface and processing circuitry, the communication interface and processing circuitry of the UE being configured to perform any of the steps of any of the Group A, C, and E Example Embodiments to receive the user data from the host.

Example Embodiment G5. The host of the previous Example Embodiment, wherein the cellular network further includes a network node configured to communicate with the UE to transmit the user data to the UE from the host.

Example Embodiment G6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G7. A method implemented by a host operating in a communication system that further includes a network node and a UE, the method comprising: providing user data for the UE; and initiating a transmission carrying the user data to the UE via a cellular network comprising the network node, wherein the UE performs any of the operations of any of the Group A embodiments to receive the user data from the host.

Example Embodiment G8. The method of the previous Example Embodiment, further comprising: at the host, executing a host application associated with a client application executing on the UE to receive the user data from the UE.

Example Embodiment G9. The method of the previous Example Embodiment, further comprising: at the host, transmitting input data to the client application executing on the UE, the input data being provided by executing the host application, wherein the user data is provided by the client application in response to the input data from the host application.

Example Embodiment G10. A host configured to operate in a communication system to provide an OTT service, the host comprising: processing circuitry configured to provide user data; and a network interface configured to initiate transmission of the user data to a cellular network for transmission to a UE, wherein the UE comprises a communication interface and processing circuitry, the communication interface and processing circuitry of the UE being configured to perform any of the steps of any of the Group A, C, and E Example Embodiments to transmit the user data to the host.

Example Embodiment G11. The host of the previous Example Embodiment, wherein the cellular network further includes a network node configured to communicate with the UE to transmit the user data from the UE to the host.

Example Embodiment G12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G13. A method implemented by a host configured to operate in a communication system that further includes a network node and a UE, the method comprising: at the host, receiving user data transmitted to the host via the network node by the UE, wherein the UE performs any of the steps of any of the Group A, C, and E Example Embodiments to transmit the user data to the host.

Example Embodiment G14. The method of the previous Example Embodiment, further comprising: at the host, executing a host application associated with a client application executing on the UE to receive the user data from the UE.

Example Embodiment G15. The method of the previous Example Embodiment, further comprising: at the host, transmitting input data to the client application executing on the UE, the input data being provided by executing the host application, wherein the user data is provided by the client application in response to the input data from the host application.

Example Embodiment G16. A host configured to operate in a communication system to provide an OTT service, the host comprising: processing circuitry configured to provide user data; and a network interface configured to initiate transmission of the user data to a network node in a cellular network for transmission to a UE, the network node having a communication interface and processing circuitry, the processing circuitry of the network node configured to perform any of the operations of any of the Group B, D, and F Example Embodiments to transmit the user data from the host to the UE.

Example Embodiment G17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment G18. A method implemented in a host configured to operate in a communication system that further includes a network node and a UE, the method comprising: providing user data for the UE; and initiating a transmission carrying the user data to the UE via a cellular network comprising the network node, wherein the network node performs any of the operations of any of the Group B, D, and F Example Embodiments to transmit the user data from the host to the UE.

Example Embodiment G19. The method of the previous Example Embodiment, further comprising, at the network node, transmitting the user data provided by the host for the UE.

Example Embodiment G20. The method of any of the previous 2 Example Embodiments, wherein the user data is provided at the host by executing a host application that interacts with a client application executing on the UE, the client application being associated with the host application.

Example Embodiment G21. A communication system configured to provide an over-the-top service, the communication system comprising: a host comprising: processing circuitry configured to provide user data for a UE, the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, D, and F Example Embodiments to transmit the user data from the host to the UE.

Example Embodiment G22. The communication system of the previous Example Embodiment, further comprising: the network node; and/or the user equipment.

Example Embodiment G23. A host configured to operate in a communication system to provide an OTT service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, D, and F Example Embodiments to receive the user data from a UE for the host.

Example Embodiment G24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment G25. The host of the any of the previous 2 Example Embodiments, wherein the initiating receipt of the user data comprises requesting the user data.

Example Embodiment G26. A method implemented by a host configured to operate in a communication system that further includes a network node and a UE, the method comprising: at the host, initiating receipt of user data from the UE, the user data originating from a transmission which the network node has received from the UE, wherein the network node performs any of the steps of any of the Group B, D, and F Example Embodiments to receive the user data from the UE for the host.

Example Embodiment G27. The method of the previous Example Embodiment, further comprising at the network node, transmitting the received user data to the host.

1. A method by a user equipment, UE, configured for Mobile Terminated-Small Data Transmission, MT-SDT for early Channel Quality Indicator, CQI, reporting, the method comprising:
before a Radio Resource Control, RRC, connection is established with a network node, receiving, from the network node, information indicating at least one Reference Signal, RS;
receiving, from the network node, the at least one RS;
based on the at least one RS, performing at least one CSI measurement; and
before the RRC connection is established with the network node, transmitting, to the network node, CSI associated with the at least one CSI measurement.

2. The method of claim 1, wherein the at least one a CSI measurement is used for MT-SDT.

3. The method of claim 1, wherein receiving the at least one RS comprises receiving a plurality of RS, and wherein the UE is configured for at least one of: periodic CSI reporting, aperiodic CSI reporting, semipersistent CSI reporting, and differential CSI reporting.

4. The method of claim 1, wherein the at least one RS comprises at least one of:
at least one Demodulation Reference Signal, DMRS, for paging on a Physical Downlink Shared Channel, PDSCH;
at least one DMRS for paging on a Physical downlink control Channel, PDCCH;
at least one DMRS for a Msg2 PDCCH or a Msg2 PDSCH;
at least one Channel State Information-Reference Signal, CSI-RS;
at least one Non-Cell Defining-Synchronization Signal Block, NCD-SSB;
at least one Channel State Information-Interference Measurement Reference Signal, CSI-IM RS;
at least one Tracking Reference Signal, TRS; and
at least one Synchronization Signal Block, SSB.

5. The method of claim 1, wherein transmitting the CSI comprises transmitting the CSI via a SDT.

6. The method of claim 1, wherein the information received from the network node comprises a CSI measurement and report configuration.

7. The method of claim 1, wherein the information is received in at least one of:
a RRCRelease message;
a System Information Block, SIB, message;
a paging message;
a Msg2 Physical Downlink Control Channel, PDCCH;
a Msg2 Physical Downlink Shared Channel, PDSCH;
Downlink Control Information, DCI; and
a System Information Block, SIB.

8. The method of claim 1, wherein prior to receiving the information from the network node, the method comprises:
transmitting, to the network node, a Msg1 in a 4-step Random Access, RA, procedure or a MsgA in a 2-step RA procedure, and
wherein the Msg1 or MsgA comprises at least one of: a Random Access Channel, RACH, preamble, a Rel-17 SDT preamble, a Rel-18 MT-SDT preamble, and a Contention-Free Random Access, CFRA, preamble.

9. The method of claim 1, wherein transmitting the CSI to the network node before the RRC connection is established comprises transmitting the CSI in:
a Msg3 in a 4-step Random Access, RA, procedure; or
a MsgB in a 2-step RA procedure.

10. The method of claim 1, wherein transmitting the CSI to the network node before the RRC connection is established comprises transmitting the CSI in an uplink message that acknowledges a previous transmission from the network node, wherein the uplink message comprises:
an uplink PUCCH message that acknowledges a Msg4 in a 4-step RA procedure;
an uplink PUSCH message that acknowledges a Msg4 in a 4-step RA procedure;
an uplink PUCCH message that acknowledges a MsgB in a 2-step RA procedure; or
an uplink PUSCH message that acknowledges a MsgB in a 2-step RA procedure.

11. The method of claim 1, wherein the information received from the network node comprises a Channel Quality Indicator, CQI.

12. The method of claim 1, wherein the UE is configured for Configured Grant-SDT, CG-SDT, and/or wherein the at least one CSI measurement comprises a CG-SDT measurement.

13. A method by a network node for early Channel Quality Indicator, CQI, reporting for small data transmission, SDT, the method comprising:
before a Radio Resource Control, RRC, connection is established with a User Equipment, UE, configured for Mobile Terminated-Small Data Transmission, MT-SDT, transmitting information indicating at least one Reference Signal, RS, to the UE;
transmitting the at least one RS to the UE; and
before the RRC connection is established with the UE, receiving CSI from the UE, the CSI being associated with at least one CSI measurement performed by the UE based on the at least one RS.

14. The method of claim 13, wherein the at least one CSI measurement is used for MT-SDT.

15. The method of claim 13, wherein transmitting the at least one RS comprises transmitting a plurality of RS, and wherein the UE is configured for at least one of: periodic CSI reporting, aperiodic CSI reporting, semipersistent CSI reporting, and differential CSI reporting.

16. The method of claim 13, wherein the at least one RS comprises at least one of:
at least one Demodulation Reference Signal, DMRS, for paging on a Physical Downlink Shared Channel, PDSCH;
at least one DMRS for paging on a Physical downlink control Channel, PDCCH;
at least one DMRS for a Msg2 PDCCH or a Msg2 PDSCH;
at least one CSI-RS;
at least one Non-Cell Defining-Synchronization Signal Block, NCD-SSB;
at least one Channel State Information-Interference Measurement Reference Signal, CSI-IM RS;
at least one Tracking Reference Signal, TRS; and
at least one Synchronization Signal Block, SSB.

17. The method of claim 13, wherein receiving the CSI comprises receiving the CSI via a SDT.

18. The method of claim 13, wherein the information transmitted to the UE comprises a CSI measurement and report configuration.

19. The method of claim 13, wherein the information is transmitted to the UE in at least one of:
a RRCRelease message;
a System Information Block, SIB, message;
a paging message;
a Msg2 Physical Downlink Control Channel, PDCCH;
a Msg2 Physical Downlink Shared Channel, PDSCH;
Downlink Control Information, DCI; and
a System Information Block, SIB.

20.-24. (canceled)

25. A user equipment, UE, configured for Mobile Terminated-Small Data Transmission, MT-SDT for early Channel Quality Indicator, CQI, reporting, the UE configured to:
before a Radio Resource Control, RRC, connection is established with a network node, receive, from the network node, information indicating at least one Reference Signal, RS;
receive the at least one RS from the network node;
based on the at least one RS, perform at least one CSI measurement; and
before the RRC connection is established with the network node, transmit CSI associated with the at least one CSI measurement to the network node.

26.-28. (canceled)
